(19) United States
(12) Patent Application Publication
(10) Pub. No.: US 2015/0339945 A1
(43) Pub. Date: Nov. 26, 2015

(54) TEACHING AID PROVIDING TACTILE FEEDBACK ASSOCIATED WITH LARGE STRINGED INSTRUMENTS

(71) Applicant: Georgeann DuBell-Shockley, Austin, TX (US)

(72) Inventor: Georgeann DuBell-Shockley, Austin, TX (US)

(21) Appl. No.: 14/721,281

(22) Filed: May 26, 2015

Related U.S. Application Data
(60) Provisional application No. 62/002,715, filed on May 23, 2014.

(51) Int. Cl. G09B 15/06

(52) U.S. Cl. CPC G09B 15/06

(57) ABSTRACT

Teaching aids for use with large stringed instruments. Teaching aids of the current embodiment comprise support structures which are releasably attached to bows. These support structures define pairs of walls between which a combination of the middle, ring, and pinky fingers are to be placed in pre-determined locations relative to the bows. Such teaching aids are adapted to guide the hands of the users into desired gripping positions relative to the bow as indicated through tactile feedback. In some embodiments, the large stringed instruments are cellos and/or double basses. Furthermore, the support structures can define second pairs of walls for the index fingers of the users and/or third pairs of walls for their thumbs. Further, the support structures can define axes and the first pairs of walls can define angles relative thereto suitable to guide the hands and fingers of the users into the gripping positions when the users are seated.

### BACKGROUND

Having a proper bow hold on the bow of a stringed instrument is essential to properly playing such an instrument. This is true for all stringed instruments be they small enough to be fully supported in one hand or so large as to be held upright while supported by the floor—such as a cello or double bass. Each style of stringed instrument requires a particular means of holding a bow. This is so because the musician generally wants a bow hold which allows for fluid movement of the bow while maintaining control of both the bow and the instrument. In the context of a cello or a double bass, this grip involves the placement of the index finger and thumb to contact the bow on opposite sides while the remaining three fingers rest alongside, but separated from, the index finger to provide proper support and power in bow movements.

### SUMMARY

Instruction in bow-handling has traditionally involved a student's visual observation of an instructor's hands on a bow. The student would then try to mimic the instructor's grip—including the bend of the fingers, their position, and the appropriate spacing. This has proved to be one of the most challenging early hurdles in the mastery of large stringed instruments which use bows. Learning and maintaining proper bow hold technique is a difficult task made more difficult in settings where instructors are responsible for the training of a large number of students. The nuances of finger placement and how it affects performance and sound can be hard to teach in such a context as it requires a great deal of consistent monitoring of each student.

These aspects of learning to play large stringed instruments can be more problematic than learning to play smaller stringed instruments in part (at least) because the students, players, users, etc. cannot easily see where their fingers are positioned on the bow of the larger stringed instruments when they are playing it. In contrast, while playing smaller stringed instruments, users can see their fingers/hands at least at some times and/or in some portions of the “strokes” involved in their play. Note that the position of the musician's arm in relation to the instrument plays a role in determining the proper bow hold technique. For a cello or double bass, the arm is generally held outward and down in front of the body usually near the waist which contrasts sharply with proper technique in holding the bow of a violin or viola where the arm is held upward nearer to the face. Yet, gaining the proper bow hold on the bow of such large instruments correctly, presents a challenge to many users. Thus, the increased tactile feedback provided by the walls disclosed herein has been found to provide unexpectedly improved learning times for students of large stringed instruments. A student can easily place this device on the bow, at the frog of the bow, and place their fingers in the assigned spaces, which allows for easy instruction and maintenance of a proper bow hold or correction to a proper bow hold. Note also that in the realm of stringed instruments, many Instructors teach either the violin and viola (small stringed instruments) or the cell and bass (large stringed instruments): but not both. Teaching aids of embodiments allow violin/viola Instructors, Band Leaders, Orchestra Conductors, and/or others unskilled with regard to playing large stringed instruments to teach cello and bass because they need not concern themselves so much with proper bow holding technique and can instead focus on the music, stroke, etc.

Within the realm of cello and double bass instruction, a device which assists students in developing and maintaining a proper bow hold and handling of a bow is desired. Such a device could provide more meaningful feedback perhaps without the need for careful visual observation by the instructor. Such a device would provide tactile feedback to students, building muscle memory of the feel of the grip, and, if desired, minimally affecting the weight and feel of the bow itself. Furthermore, such a device could accommodate a range of hand sizes, cello or double bass bow sizes, and could be easy to install or remove.

Various embodiments herein provide teaching aids for use with large stringed instruments and their associated bows which define bow frogs. The teaching aids of the current embodiment comprise support structures adapted to be releasably attached in proximity to the bow frogs. Furthermore, the support structures define first pairs of walls between which a combination of the middle, ring, and pinky fingers of the users are to be placed in pre-determined locations relative to the bows. The teaching aids of the current embodiment are adapted to guide the hand and the combination of the middle, ring, and pinky fingers of the users into desired gripping positions relative to the bows as indicated through tactile feedback from the support structures.

In some embodiments, the large stringed instruments are cellos and/or double bass instruments. Furthermore, the support structures can define second pairs of walls between which the index fingers of the users are to be placed. Further still, the support structures can define third pairs of walls between which the thumbs of the users are to be placed. In addition, or in the alternative, the support structures can define longitudinal axes and wherein the first pairs of walls define angles relative thereto suitable to guide the hands and combinations of the middle, ring, and pinky fingers of the users into the desired gripping positions relative to the bows when the users assume seated postures holding the large stringed instruments.

To the accomplishment of the foregoing and related ends, certain illustrative aspects are described herein in connection with the annexed figures. These aspects are indicative of various non-limiting ways in which the disclosed subject matter may be practiced, all of which are intended to be within the scope of the disclosed subject matter. Other novel and nonobvious features will become apparent from the following detailed disclosure when considered in conjunction with the figures and are also within the scope of the disclosure.

### BRIEF DESCRIPTION OF THE FIGURES

The detailed description is described with reference to the accompanying figures. In the figures, the left-most digit(s) of a reference number usually corresponds to the figure in which the reference number first appears. The use of the same reference numbers in different figures usually indicates similar or identical items.

FIG. 1 illustrates a teaching aid being used by a user.

FIG. 2 is a view of a teaching aid installed on bow associated with a large stringed instrument.

FIG. 3 is a side view of a teaching aid.

FIG. 4 is a side view of a teaching aid showing walls for the thumb.

FIG. 5 is a side view of a teaching aid being installed on a bow of a large stringed instrument.

FIG. 6 is a top view of the proximal end of a teaching aid.

FIG. 7 is a cross-sectional view of a teaching aid showing the walls for the index finger.

FIG. 8 is a cross-sectional view of a teaching aid showing the walls for the thumb.

FIG. 9 is a cross-sectional view of a teaching aid showing the walls for the combination of the middle, ring, and pinky fingers.

FIG. 10 is another side elevation view of a teaching aid.

### DETAILED DESCRIPTION

This document discloses systems, apparatus, methods, etc. associated with large stringed instrument teaching aids. The current disclosure provides teaching aids for use with large stringed instruments and more particularly flexible teaching aids which guide the users' hands into proper bow-gripping positions and which provide tactile feedback thereof.

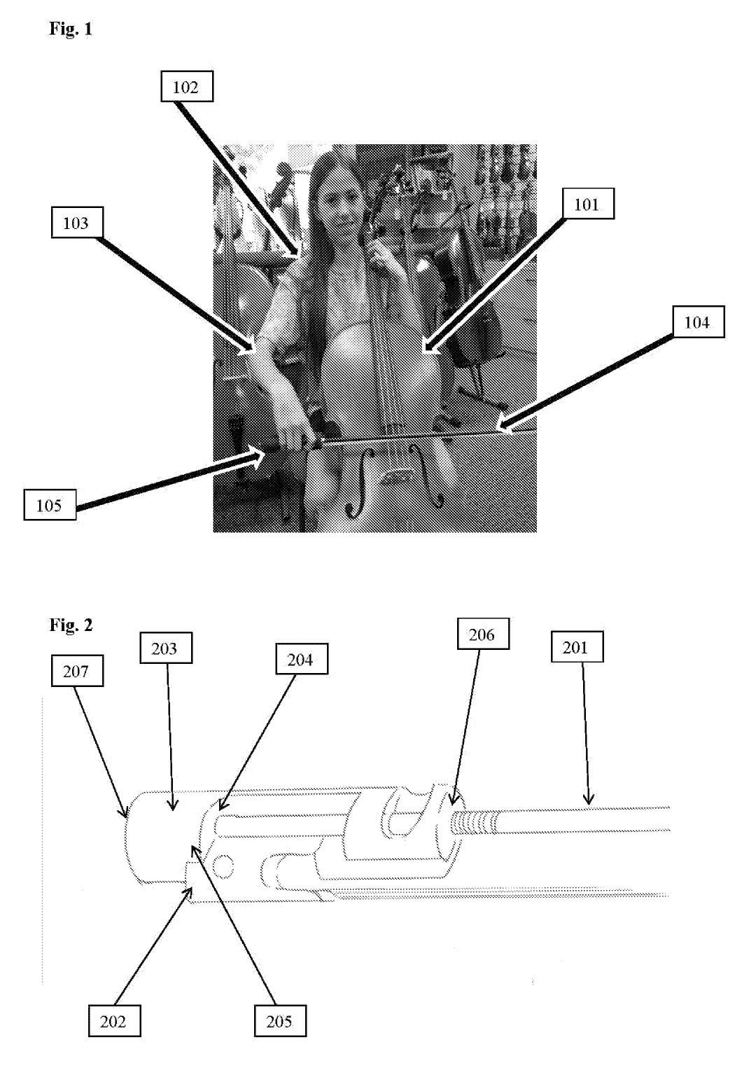

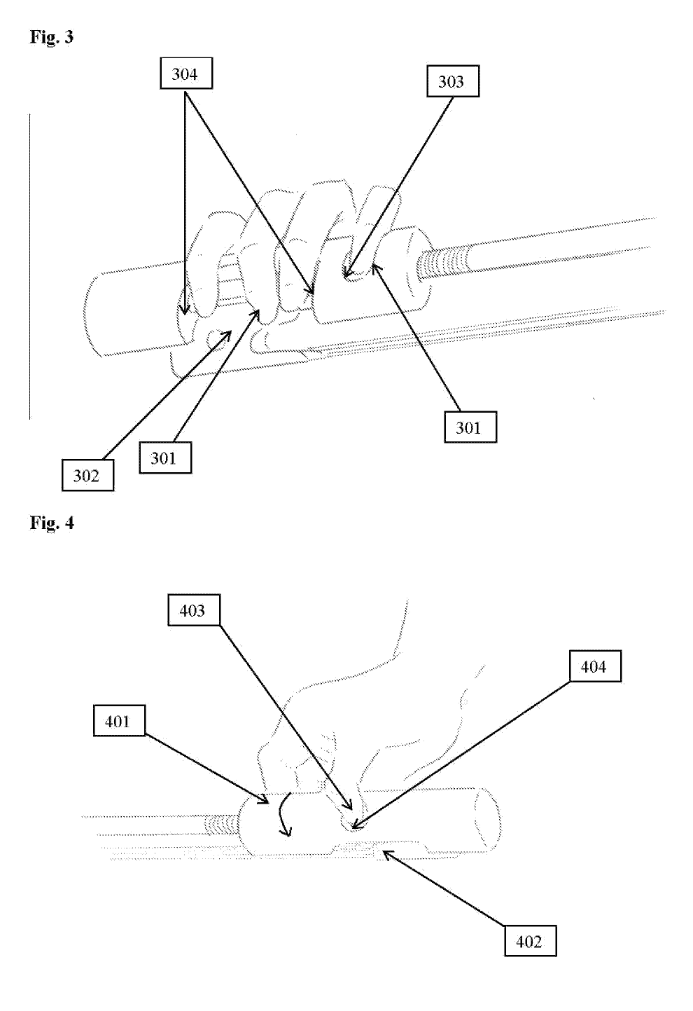

FIG. 1 depicts an embodiment of a cello-specific teaching aid (105) in use but other embodiments provide teaching aids for other large stringed instruments. The pictured user (102) is shown seated with correct posture with the instrument (101) and right arm held in the proper position (103) when handling the bow (104). The teaching aid (105) here is installed on the cello's bow (104) and the user's fingers fit between the walls of the teaching aid which therefore provides tactile feedback indicating that the fingers are in the correct positions (301, 302, and 403, see FIGS. 3 and 4). These positions provide users with a bow grip which allows for fluid motion of, and maintaining control over, the bow and instrument.

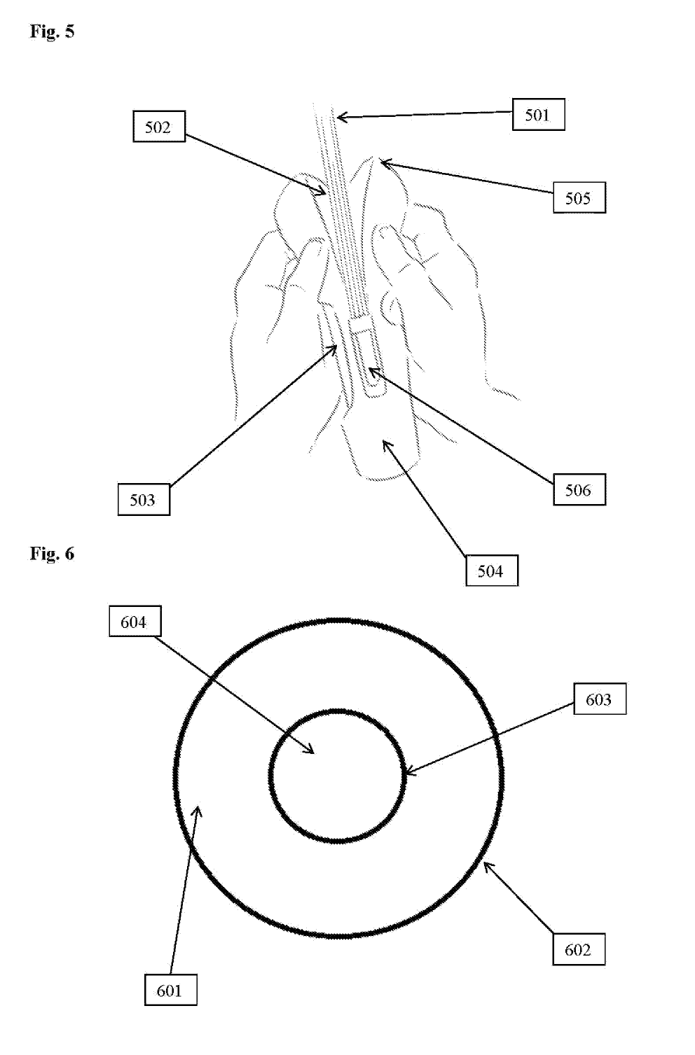

FIG. 2 illustrates a teaching aid (203) and a bow stick (201) associated with a large stringed instrument (for instance a cello or bass) and a bow frog (202) defined thereby. As shown, the teaching aid (203) is generally cylindrical in shape with a distal end (206) and a proximal end (207 and 601, see FIGS. 2 and 6) with outer surfaces (205 and 602, see FIGS. 2 and 6) defined there between. Between the distal end (206) and the proximal end (207, 601) a longitudinal passageway (502, 604, and 703, see FIGS. 5, 6, and 7) defined by a generally cylindrical inner surface (204, 603) (and which secures the cello's bow stick (201)) runs coaxially with the outer surface (205, 602). The outer surface of the teaching aid (205, 602) of the current embodiment is 1.25 to 1.50 inches in diameter while the inner surface (204, 603) is 0.375 to 0.50 inches in diameter. Note that the specific dimensions disclosed herein are non-limiting.

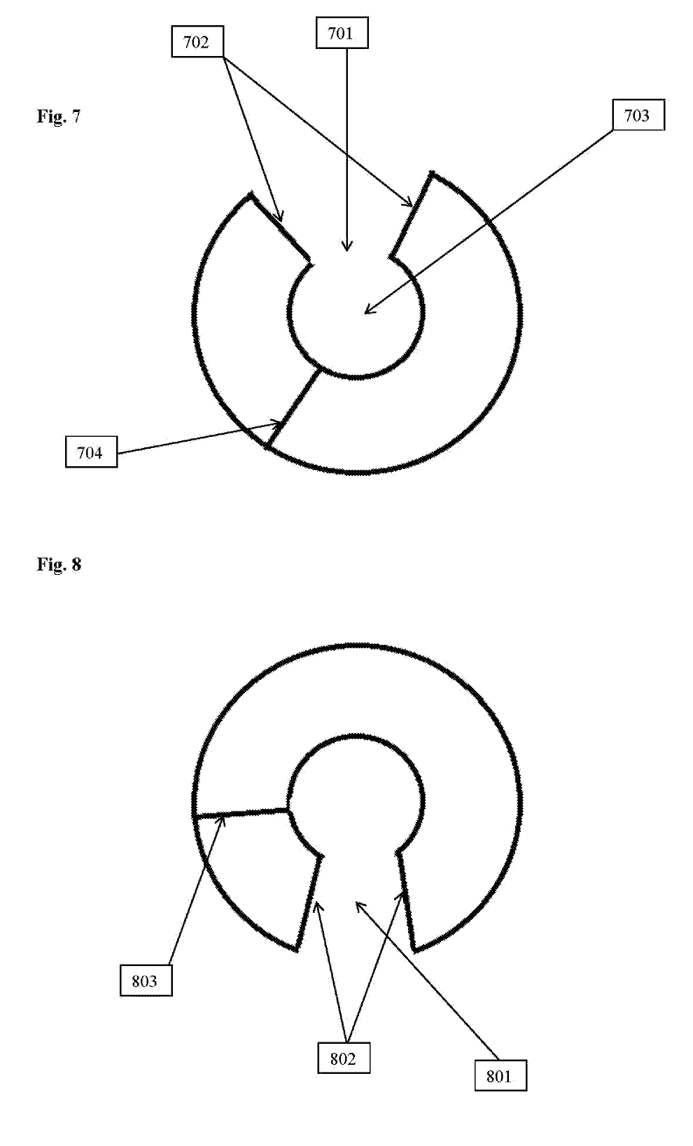

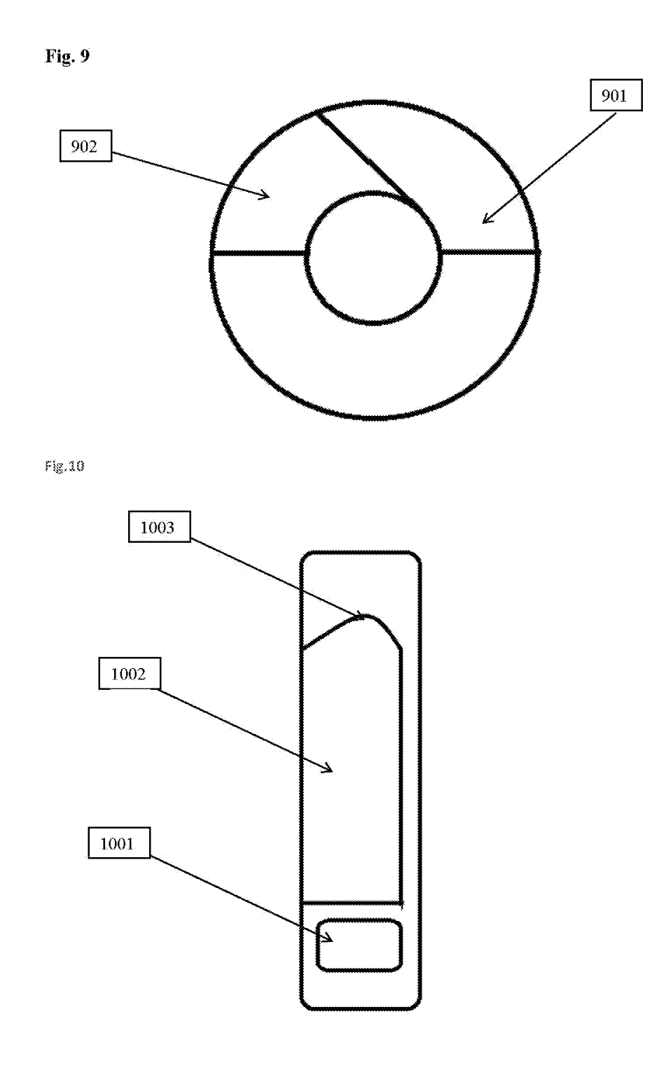

The teaching aids (504) of the current embodiment are designed to be releasably secured to a cello/bass bow as depicted in FIG. 5. The surface of the longitudinal passageway (502, 604, 703, see FIGS. 5, 6, and 7) flexes to secure a large instrument's bow frog (506 and 902, see FIGS. 2 and 9) and bow stick (501) as the teaching aid (504) is being installed on the bow stick (501). A small separation (704 and 803, see FIGS. 7 and 8) of the outer surface (205, 602) that runs between the distal end (505) and the aperture corresponding to the middle, ring, and pinky fingers (503) allows for installation as shown thereby requiring no disassembly of the large stringed instrument bow for installation thereon. When installed on a cello/bass bow, the teaching aid (504) can remain stationary in relation to the bow during normal use. In some embodiments, the inner surface (204, 603) may have a smaller diameter such that the inner surface is expanded when the teaching aid is installed on a cello bow. This will typically result in a generally secure installation of the teaching aid on the bow due to frictional resistance to movement between the teaching aid and the instrument's bow.

A plurality of apertures (301, 302, 403, 701, and 802, see FIGS. 3, 4, 7, and 8) along the outer surface (205, 602) of the teaching aid intersect and open into the longitudinal passageway (502, 604, 703) to form sets of walls (303, 304, 404, 702, 802, and 901, see FIGS. 3, 4, 7, and 8) which indicate, through tactile feedback to the user, correct/incorrect finger placement with respect to the locations at which the fingers are to make contact with (and, hopefully, are making contact with) the cello/bass bow. The apertures (301, 302, 403, 701, and 802, see FIGS. 3, 4, 7, and 8) and corresponding sets of walls (303, 304, 404, 702, 802, and 901, see FIGS. 3, 4, 7, and 8) are adapted to receive the corresponding fingers of a user's right hand. The distance between the outer surfaces (205, 602) and the inner surfaces (204, 603) should be sufficient to allow the walls created by the apertures in the outer surface (205, 602) to be discernible by touch.

In the disclosed embodiment, apertures (301 and 701, see FIGS. 3 and 7) are adapted to receive the index finger of the user's right hand, apertures (302) are adapted to receive the combination of the user's middle, ring, and pinky fingers, and apertures (403 and 801, see FIGS. 4 and 8) are adapted to receive the user's thumb. Apertures (301, 701 and 302, see FIGS. 3 and 7) are situated adjacent to one another with a non-limiting distance of 0.25 inches between them. Apertures (403 and 801) can be located approximately 0.6125 inches away from aperture 302 (see also aperture 402, FIG. 4) in the direction which the right hand curves between the index finger and the thumb when the user grips a cylindrical object.

The apertures (301, 302, 403, 701, and 801, see FIGS. 3, 4, 7, and 8) together provide tactile indications to the user of correct finger placement with respect to the pre-determined locations of contact between the user's fingers and a large stringed instrument bow. Utilizing a single aperture for the middle, ring, and pinky fingers not only facilitates manufacturing of the teaching aids and installation of the teaching aids on a large stringed instrument bow, but it also emphasizes the functionality of using three fingers in anchoring control of a large stringed instrument bow proximal to the bow frog (as contrasted with multiple walls for corresponding to individual fingers).

The lateral contour of the sets of walls (303, 304, 404, 702, 802, and 901, see FIGS. 3, 4, 7, and 8) can provide tactile indications of the desired angle in which the tip or tips of corresponding fingers make contact with a cello/bass bow. The measure of this angle may vary between embodiments with the type and/or size of the large stringed instrument with which it is intended to be used.

Some embodiments provide teaching aids which can vary in material, size, and weight. A lighter weight teaching aid can minimize the difference between playing a cello aided by the teaching aid and playing a cello without a teaching aid. Additionally, a teaching aid comprised predominantly of sponge rubber and sufficiently flexible to be deformed during installation of the bow is provided by embodiments. Teaching aids of embodiments can vary in size depending on instrument and user-hand sizes.

Embodiments disclosed herein provide teaching aids for the bows of large stringed instruments. Some teaching aids comprising a generally cylindrical outer surface, a generally cylindrical inner surface, apertures in the outer surface which intersect the inner surface, and resulting walls from these apertures, provide tactile indication of pre-determined locations where a user's fingers are intended to make contact with a bow for a large stringed instrument.

### CONCLUSION

Although the subject matter has been disclosed in language specific to structural features and/or methodological acts, it is to be understood that the subject matter defined in the appended claims is not necessarily limited to the specific features or acts disclosed above. Rather, the specific features and acts described herein are disclosed as illustrative implementations of the claims.

What is claimed is:

1. A teaching aid for use with a large stringed instrument associated with a bow, the bow defining a bow frog, the teaching aid comprising:
a support structure adapted to be releasably attached in a proximity of the bow frog;
the support structure defining a first pair of walls between which a combination of middle, ring, and pinky fingers of a user are to be placed in a pre-determined location relative to the bow associated with the large stringed instrument; and
the support structure being adapted to guide a hand and the combination of the middle, ring , and pinky fingers of the user into an intended gripping position relative to the bow as indicated through tactile feedback from the support structure.

2. The teaching aid of claim 1 wherein the large stringed instrument is one of a cello or a double bass.

3. The teaching aid of claim 1 wherein the support structure further defines a second pair of walls between which an index finger of the user is to be placed.

4. The teaching aid of claim 1 wherein the support structure further defines a third pair of walls between which a thumb of the user is to be placed.

5. The teaching aid of claim 1 wherein the support structure defines a longitudinal axis and wherein the first pair of walls define an angle therewith suitable to guide the combination of the middle, ring, and pinky fingers of the user into the desired gripping position relative to the bow when the user assumes a seated posture and is holding the large stringed instrument.

6. The teaching aid of claim 1 wherein the support structure is formed of sponge rubber.

7. The teaching aid of claim 1 wherein the support structure has a generally cylindrical outer surface.

8. The teaching aid of claim 1 wherein the support structure has a generally cylindrical inner surface which is generally coaxial with the generally cylindrical outer surface, which defines a longitudinal passageway adapted to receive a stick of a bow associated with the large stringed instrument.

9. The teaching aid of claim 1 wherein the walls define apertures in the outer surface.

10. The teaching aid of claim 1 wherein a diameter of the outer surface is equal to or less than approximately 2.0 inches.

11. The teaching aid of claim 1 wherein a diameter of the outer surface is approximately 1.50 inches.

12. The teaching aid of claim 1 wherein the support structure further defines a passageway adapted to allow the teaching aid to be releasably attached to a bow of the large stringed instrument.
